(19) United States
(12) Patent Application Publication
(10) Pub. No.: US 2008/0062707 A1
(43) Pub. Date: Mar. 13, 2008

(54) LED illuminator collimation module and its holder

(76) Inventor: Chao Hsien Wu, Taipei (TW)

Correspondence Address: Raymond Sun, 12420 Woodhall Way, Tustin, CA, 92782, US

(21) Appl. No.: 11/518,061

(22) Filed: Sep. 8, 2006

(51) Int. Cl. B60R 1/12

(52) U.S. Cl. 362/494

(57) ABSTRACT

The present invention provides an LED illuminator collimation module that can be installed in the optical engine of a projector. The LED illuminator collimation module comprises an LED base, a collimator, and a holder. The holder further comprises a first clamping holder and a second clamping holder. The collimator can be quickly fixed between the first clamping holder and the second clamping holder forming a ferrule, which utilizes a clip configuration to implement a quick clip fixing. On the other hand, between the holder and LED base, a positioning mechanism is used to provide an accurate secure fixing for the holder on the LED base so that the collimator can collimate the lights emitted from the LED on the LED base accurately and efficiently and can achieve optimized collimation effect.

### BACKGROUND OF INVENTION

1. Field of the Invention

The present invention relates to an LED illuminator collimation module, in particular to a holder being used to fix a collimator on the LED base of a projector accurately and quickly.

2. Description of the Prior Art

Since advanced science and technology are developing rapidly, especially in the field of microelectronics-related technology related to the manufacturing process, changes have come fast and constantly. Electronic related products have been widely used by every family and various industries, and have become essential elements of modern life.

As the demands of people have been increasing, it is certainly important to provide more multifunctional electric devices to meet the needs and the trend of electronic products toward the objectives of multifunction and configuration featuring as a slim volume. As many other electronic products, the development and application of projectors also provide great convenience for the life of people. As the advance of projector technology, in view of small, light and portable projector products and constantly upgraded laptop with its increasing sales and popularization, multi-media minute news have become a fashion. Originally, projecting products were used for the purpose of Office Automation (OA) as its main market, while in the future, it will soon take up the market of Personal Computer (PC) in addition to the development of consumptive electronic products market. While the future trend of development for the whole projecting products will focus on the three directions of upgraded function, lower price and smaller size.

At present, with reference to the relatively small-sized DLP projector in the market, its theory is as shown in FIG. 1. A DLP projector comprises: an illuminator module A, a condenser B, a prism module C, a Digital Micro-mirror Device (DMD) D, and a projection lens set E. The lights emitted from the illuminator module A first then pass through the condenser B, and then are refracted by the prism module C to the Digital Micro-mirror Device D on which the lights are reflected to form reflex imaging and then refracted again by the prism module C to the projection lens set E and finally, focused on the light, the image is displayed on an external projection screen F.

With reference to the illuminator module A, it mainly comprises an LED light source collimator modules G which can emit three different colors (red, blue, and green), a plurality of Light Filters H (as shown in FIG. 2), wherein each LED light source collimator module G further comprises an LED base I and a collimator J which focuses and increases the brightness of the light generated from LED K on the LED base. Therefore, the accuracy of relative positions of the collimator J and the LED K affects collimation efficiency of the collimator J.

According to the requirements for the feature of collimator J, there is a limitation on contact between the collimator and the holding or fixing device, otherwise, the collimation efficiency is affected. Therefore, how to improve accuracy and simplify the clamping holder so as to be suitable for mass production is a problem yet to be solved, and is an issue that demand further efforts, research and development from manufacturers to overcome.

### SUMMARY OF INVENTION

The main objective of the present invention is to provide an LED illuminator collimation module and its holder, wherein a collimator can be positioned and fixed on an LED base accurately and quickly, meanwhile, can also minimize a contact surface between the holder and the collimation module so as to optimize the collimation efficiency.

The second objective of the present invention is to provide a holder of the LED illuminator collimation module, wherein the holder comprises a pair of symmetric pieces, which can save the cost of molds so as to provide more competitive prices.

The third objective of the present invention is to provide a holder of the LED illuminator collimation module, which adopts modularized design so as to provide convenience for the assembly and improve the quality and the stability of the product.

In order to achieve the above objectives, the present invention provides the LED illuminator collimation module that mainly comprises an LED base, a collimator, and the holder. The holder further comprises a first clamping holder and a second clamping holder. On the other hand, the collimator can be fixed between a first clamping holder and a second clamping holder very quickly by utilizing a clip configuration to implement a quick click fixing. Further, between the holder and the LED base, a positioning configuration is used to provide accuracy and efficiency for fixing the holder on the LED base.

With reference to a preferred embodiment, wherein a circular flange is further setup along the circumference of the collimator and in its corresponding position of both the first clamping holder and the second clamping holder, there is also a semi-circular groove on each of them respectively, which is ready for click fixing with the circular flange. Entirely depending on the click fixing mechanism of the circular flange and the two semi-circular grooves alone, the collimator can be positioned and fastened between the first clamping holder and the second clamping holder steadily enough. In other words, the collimator except for its circular flange contacts for click fixing with the grooves of both the first and the second clamping holder, the rest part of the collimator does not contact with any other part of the first and second clamping holders, which minimizes the contact surface between the collimator and other components so as to improve the collimation efficiency of the collimator accordingly.

### BRIEF DESCRIPTION OF THE DRAWINGS

The details of the present invention will be more readily understood from a detailed description of the preferred embodiments taken in conjunction with the following figures.

FIG. 1 is an optical schematic view of DLP projector in prior arts;

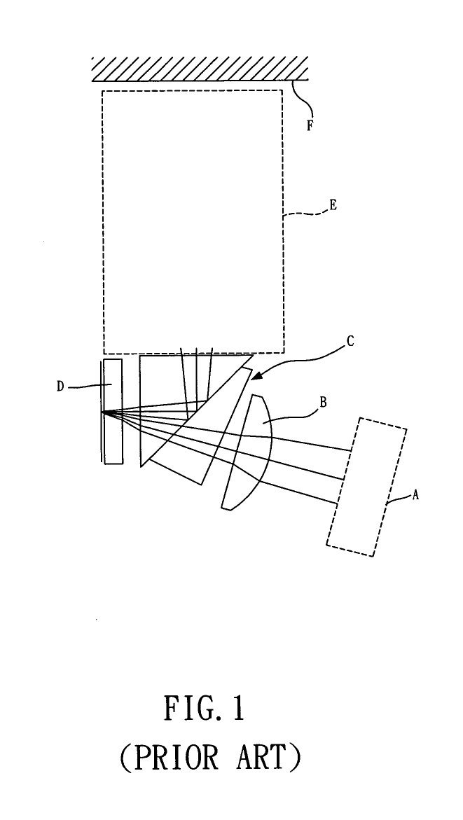

FIG. 2 is a sectional schematic view of an optical engine of a projector in prior arts;

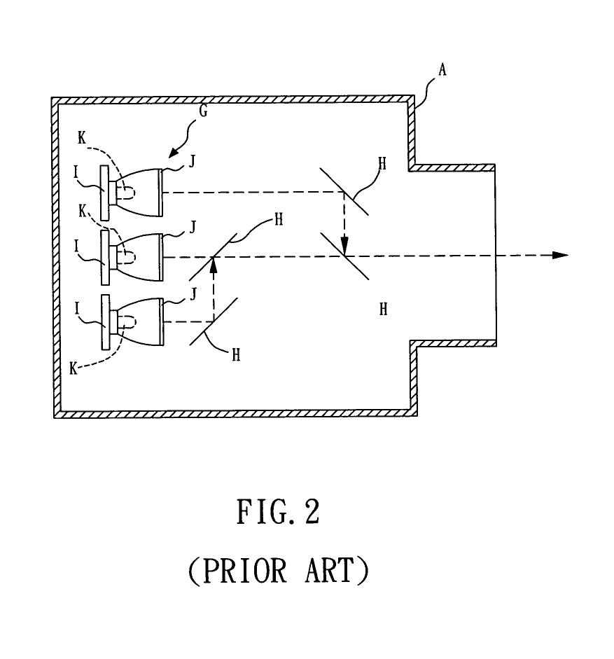

FIG. 3 is a three-dimensional exploded view of a preferred embodiment in the present invention;

FIG. 4 is s three-dimensional outside view of the preferred embodiment in the present invention;

FIG. 5 is a sectional schematic view of the preferred embodiment in the present invention.

### DETAILED DESCRIPTION

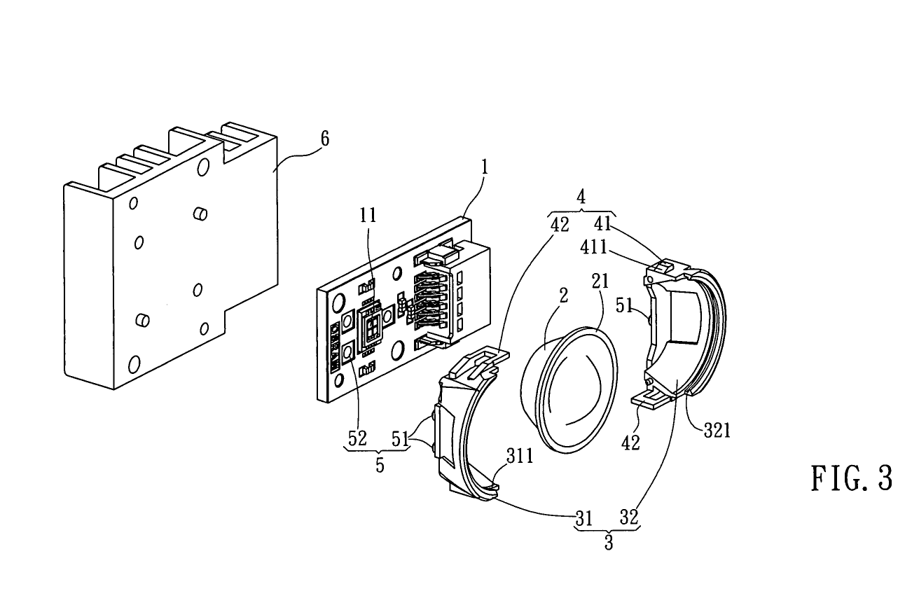

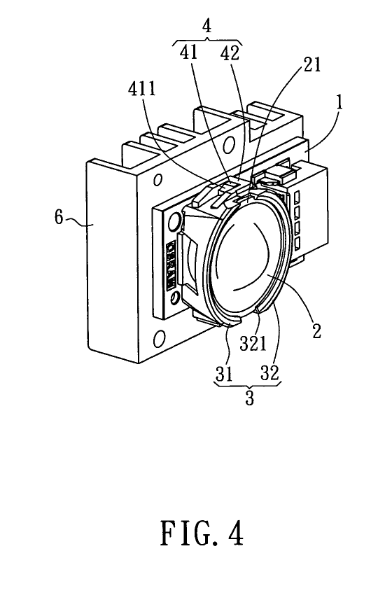

With reference to the drawings shown in FIG. 3 and FIG. 4, wherein illustrate a three-dimensional exploded view and a three-dimensional outside view of a preferred embodiment in the present invention. The LED illuminator collimation module of the present invention can be installed in an optical engine of a projector as a light source from which lights are focused and projected to the Digital Micro-mirror Device (DMD) for producing an image. The LED illuminator collimation module mainly comprises: an LED base 1, a collimator 2, and a holder 3; on the LED base 1, an installed LED 11 as a light source, several electronic circuit components and connectors used to connect with other parts of the projector or power supplies, etc.

With reference to the collimator 2, which has a circular flange 21 and its position is corresponding to the LED 11 to produce collimation function. The holder 3 further comprises both a first clamping holder 31 and a second clamping holder 32, which can be separated from each other. With reference to the first clamping holder 31 and the second clamping holder 32 having semi-circle grooves 311 and 321 respectively, whose positions are corresponding to the circular flange 21 of the collimator 2 mentioned above, so that both the first clamping holder 31 and the second clamping holder 32 can act together to clip the collimator 2 inside quickly to implement the click fixing function. With reference to the preferred embodiment of the present invention, the mechanism design of the first clamping holder 31 and the second clamping holder 32 is depicted as follows: (a) entirely depending on the click fixing mechanism of circular flange 21 and the two semi-circle grooves 311 and 321 alone, the collimator 2 can be positioned and fastened between the first and second clamping holders 31, 32 steadily enough; and (b) with reference to the collimator 2, wherein except for its circular flange 21 contacts with the semi-circular grooves 311 and 321 of both the first and the second clamping holders 31 and 32 for their click fixing, the rest part of the collimator 2 would not contact with any other part of the first and second clamping holders 31 and 32. Such a unique configuration design of holder 3 in the present invention can minimize the contact surface between the collimator 2 and other components (e.g. holder 3) so as to improve the collimation efficiency of the collimator 2 accordingly.

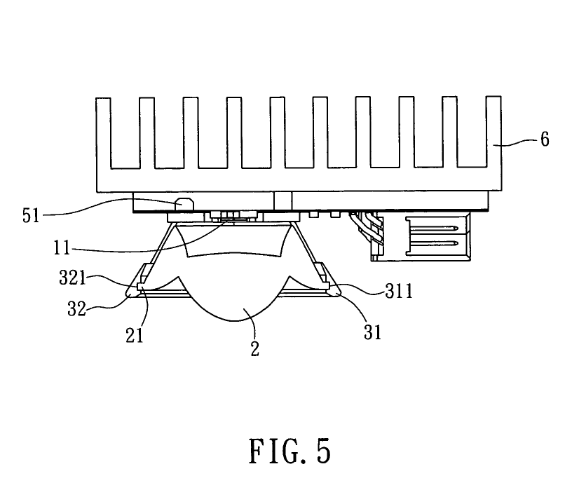

The holder 3 further has a clip configuration 4, wherein the first clamping holder 31 and the second clamping holder 32 joint together with just a quick click fixing (as shown in FIG. 5). On the other hand, between the holder 3 and the LED base 1, there is a positioning mechanism 5 that provides quick and accurate fixing of the holder 3 on the LED base 1. Thus, the collimator 2 can collimate the lights emitted from the LED 11 on the LED base 1 accurately, and efficiently, so as to optimize the collimation effect.

With reference to the configuration of the present invention as mentioned in the forepart, wherein the clip configuration 4 further has a protruding lump fixture 41 and a clip fixing part 42 whose positions are corresponding to the first clamping holder 31 and the second clamping holder 32 so as to combine each other. On the protruding lump fixture 41 near a side of the clip fixing part 42, there is an Inclined Plane 411. With reference to the design of the Inclined Plane 411, when the first clamping holder 31 and the second clamping holder 32 joint together, the clip fixing part 42 is pushed beside by the incline plane 411 of the protruding lump fixture 41 in the initial stage of jointing with the protruding lump fixture 41 and the action keep pushing against the inclined Plane 411 up to the clip fixing part 42 is positioned and bounced by its own elasticity so as to implement the function of clip joint fixing with efficiency.

As mentioned in the configuration of the present invention above, the positioning mechanism 5 is used for accurate fixing of the holder 3 on the LED base 1, and further there are at least one positioning convex post 51 and at least one positioning concave hole 52 in the corresponding positions of the holder 3 and the LED base 1, which are used for conjugating each other. The positioning convex post 51 on the holder 3 can be fixed quickly into the positioning concave hole 52 on the LED base 1 so as to implement the positioning function for both of them quickly with accuracy, at the same time, the position of the collimator 2 is exactly allocated above the LED 11 of the LED base 1.

As shown in the configuration of the present invention above, the holder 3 comprises the first clamping holder 31 and the second clamping holder 32 and in order to simplify the mold, the present invention adopts symmetric pattern in the design of the clip configuration 4, wherein the first clamping holder 31 and the second clamping holder 32 have the same figuration mechanism. Thus, it needs to develop only one set of molds for the production of both the first clamping holder 31 and the second clamping holder 32 so as to not only save development costs, but also to make more convenient the assembly and storage of products, and in addition, to accelerate the assembly speed.

As shown in the configuration of the present invention above, in addition to the LED base 1, the collimator 2, and the holder 3, further includes a Heat dissipator 6. The Heat dissipator 6 is installed at the back of the LED base 1, namely, the LED base 1 is installed between the heat dissipator 6 and the holder 3. The Heat dissipator 6 is used for the quick and efficient dissipation of the heat transmitted from the LED 11 of the LED base 1.

Although the present invention has been described with reference to the preferred embodiment thereof, it is apparent to those skilled in the art that a variety of modifications and changes may be made without departing from scope of the present invention which is intended to be defined by the appended claims, for instance, the changes of clip joint fixture and positioning mechanism of the present invention are all include in the scope of the present invention.

With reference to the LED illuminator collimation module of the projector in the present invention, wherein the significant improvement is made on the deficiencies of the poor collimation performance caused by the inaccurate and unsteady positioning between the collimator and the LED. Meanwhile, further using modularization mechanism, the configuration is greatly simplified, which is suitable for mass production and also have the advantage of reducing production costs so as to meet the needs of various industries and make them more competitive.

Those skilled in the art will readily observe that numerous modifications and alterations of the device may be made while retaining the teachings of the invention. Accordingly, that above disclosure should be construed as limited only by the metes and bounds of the appended claims.

What is claimed is:

1. An LED illuminator collimation module, comprising:
an LED base, an LED being on the LED base;
a collimator furnished on a position corresponding to the LED; and
a holder for holding the collimator, said holder further including a positioning mechanism for fixing the holder on the LED base.

2. The LED illuminator collimation module as claimed in claim 1, wherein the holder further comprises a first clamping holder and a second clamping holder.

3. The LED illuminator collimation module as claimed in claim 2, wherein a clip configuration is utilized to implement clip joint fixing between the first clamping holder and the second clamping holder.

4. The LED illuminator collimation module as claimed in claim 3, wherein the clip configuration further have a protruding lump fixture and a clip fixing part on corresponding positions of both the first clamping holder and the second clamping holder, which can combine with each other.

5. The LED illuminator collimation module as claimed in claim 4, wherein a side of the protruding lump fixture near the clip fixing part has an inclined plane.

6. The LED illuminator collimation module as claimed in claim 2, wherein the first clamping holder and the second clamping holder both have same figurations.

7. The LED illuminator collimation module as claimed in claim 1, wherein the positioning mechanism further has at least one positioning convex post and at least one positioning concave hole on corresponding positions of the holder and the LED base, which can combine with each other.

8. The LED illuminator collimation module as claimed in claim 2, wherein the collimator further has a circular flange, in addition, each of the first and second clamping holders has a semi-circle groove formed on a position corresponding to the circular flange, the semi-circle grooves of the first and second clamping holders can combine with each other for clamping and receiving the circular flange.

9. The LED illuminator collimation module as claimed in claim 1, wherein in addition to the LED base, the collimator and the clamping holder, the module further comprises a heat dissipater which is installed at a back of the LED base; namely, the LED base is allocated between the heat dissipator and the holder.

10. An LED illuminator collimation module, comprising:
an LED base, an LED being on the LED base;
a collimator located above the LED of the LED base to collimate light; and
a holder having a first clamping holder and a second clamping holder, which can be separate from each other, and the first clamping holder and second clamping holder have a clip configuration which can combine together to hold the collimator between the first clamping holder and the second clamping holder, and also the holder further has a positioning mechanism for fixing the holder on the LED base.

11. The LED illuminator collimation module as claimed in claim 10, wherein the clip configuration further have a protruding lump fixture and a clip fixing part on corresponding positions of both the first clamping holder and the second clamping holder, which can combine each other.

12. The LED illuminator collimation module as claimed in the claim 11, wherein a side of the protruding lump fixture near the clip fixing part has an inclined plane.

13. The LED illuminator collimation module as claimed in claim 10, wherein the first clamping holder and the second clamping holder both have same figurations.

14. The LED illuminator collimation module as claimed in the claim 10, wherein the positioning mechanism further has at least one positioning convex post and at least one positioning concave hole on corresponding positions of the holder and the LED base, which can combine each other.

15. The LED illuminator collimation module as claimed in claim 10, wherein the collimator further has a circular flange; in addition, each of the first and second clamping holders has a semi-circle groove formed on a position corresponding to the circular flange, and the semi-circle grooves of the first and second clamping holders can combine with each other for clamping and receiving the circular flange.

16. The LED illuminator collimation module as claimed in claim 15, wherein the collimator can be positioned and fastened between the first clamping holder and the second clamping holder steadily merely by means of the clip fixing combination of the circular flange and the semi-circular grooves.

17. The LED illuminator collimation module as claimed in claim 15, wherein the collimator, except for its circular flange contacts with the semi-circle grooves on the first clamping holder and the second clamping holder for the clip fixing, no other portion of the collimator will contact any part of the first and second clamping holders.

18. The LED illuminator collimation module as claimed in the claim 10, in addition to the LED base, the collimator, and the clamping holder, the module further comprises a heat dissipater which is installed at a back of the LED base; namely, the LED base is allocated between the heat dissipator and the clamping holder.

19. A holder of an LED illuminator collimation module having an LED base and a collimator; the holder comprising:
a first clamping holder;
a second clamping holder;
a clip configuration being set between the first clamping holder and the second clamping holder correspondingly, by which the first clamping holder and the second clamping holder combine together to clamp and hold the collimator there between; and
a positioning mechanism being disposed on the first clamping holder and the second clamping holder for fixing the first clamping holder and the second clamping holder together with the collimator into a pre-determined position on the LED base.

20. The holder of the LED illuminator collimation module as claimed in claim 19, wherein the collimator further has a circular flange; in addition, each of the first and second clamping holders has a semi-circle groove formed on a position corresponding to the circular flange, and the semi-circle grooves of the first and second clamping holders can combine with each other for clamping and receiving the circular flange.
